(19) United States
(12) Patent Application Publication
(10) Pub. No.: US 2024/0253718 A1
(43) Pub. Date: Aug. 1, 2024

(54) VEHICLE WINDSHIELD INSTALLATION DEVICE AND VEHICLE WINDSHIELD INSTALLATION METHOD

(71) Applicant: Honda Motor Co., Ltd., Tokyo (JP)

(72) Inventor: Yuriko SUZUKI, Tokyo (JP)

(73) Assignee: Honda Motor Co., Ltd., Tokyo (JP)

(21) Appl. No.: 18/537,803

(22) Filed: Dec. 13, 2023

(30) Foreign Application Priority Data
Jan. 30, 2023 (CN) 202310045721.3

(51) Int. Cl. B62D 65/06; B62D 65/02

(52) U.S. Cl. CPC B62D 65/06; B62D 65/024

(57) ABSTRACT

A vehicle windshield installation device is adapted to install a vehicle windshield to an opening part of a vehicle body and includes: a holding member, holding the vehicle windshield; an information acquisition member, acquiring sensing information to which a paint color of the vehicle body corresponds, the sensing information at least including a position of a cross-section to be sensed on an edge of the opening part; a sensing member, sensing the cross-section to be sensed, which is set in advance, on the edge of the opening part; and a calculation member, calculating an installation position of the vehicle windshield according to a sensing result acquired through sensing. The holding member installs the vehicle windshield to the opening part according to the installation position of the vehicle windshield that is calculated. A vehicle windshield installation method is also provided.

### CROSS-REFERENCE TO RELATED APPLICATION

This application claims the priority benefit of China application no. 202310045721.3, filed on Jan. 30, 2023. The entirety of the above-mentioned patent application is hereby incorporated by reference herein and made a part of this specification.

### BACKGROUND

### Technical Field

The disclosure relates to a vehicle windshield installation device and a vehicle windshield installation method.

### Description of Related Art

In the conventional art, a vehicle windshield may be installed to an opening part, as a window, provided in a vehicle body by using a holding member, such as a robot arm. During the installation process, a sensing member, such as a sensor, may be used to position the vehicle windshield, so that the vehicle windshield may be more accurately bonded to the edge of the opening part. During the process of positioning the vehicle windshield, one or more cross-sections on the edge of the opening part may be sensed by using the sensing member, so as to determine an installation position of the vehicle windshield (e.g., determine the position of the vehicle windshield on the upper side and the left and right sides). However, after the surface of the vehicle body is painted, the sensing member may not be able to accurately sense the shape of the edge of the opening part. For example, when the vehicle body is painted black, as black color hardly reflects light, the outline of the cross-section of the edge of the opening in the vehicle body becomes unclear. Correspondingly, when the vehicle body is painted white, as white color reflects light easily, the outline of the cross-section of the edge of the opening part in the vehicle body is rough. Thus, it is difficult for the sensing member to detect the original shape of the cross-section of the edge of the opening part in the vehicle body that has been painted. As a result, an error may be present in the installation position of the vehicle windshield that is determined. Thus, the influence of the paint color of the vehicle body needs to be taken into consideration in the process of setting in advance the position of the cross-section to be sensed on the edge of the opening part.

### Prior Art Document(s)

### Patent Document(s)

[Patent Document 1] Japanese Laid-open No. 2004-359069

The disclosure provides a vehicle windshield installation device and a vehicle windshield installation method, capable of taking into consideration a paint color of a vehicle body and accurately installing a vehicle windshield.

### SUMMARY

An aspect of the disclosure provides a vehicle windshield installation device. The vehicle windshield installation device is adapted to install a vehicle windshield to an opening part of a vehicle body and includes: a holding member, holding the vehicle windshield; an information acquisition member, acquiring sensing information to which a paint color of the vehicle body corresponds, the sensing information at least including a position of a cross-section to be sensed on an edge of the opening part; a sensing member, sensing the cross-section to be sensed, which is set in advance, on the edge of the opening part; and a calculation member, calculating an installation position of the vehicle windshield according to a sensing result acquired through sensing. The holding member installs the vehicle windshield to the opening part according to the installation position of the vehicle windshield that is calculated.

Another aspect of the disclosure provides a vehicle windshield installation method. The vehicle windshield installation method is adapted to install a vehicle windshield to an opening part of a vehicle body and includes: a holding step for holding the vehicle windshield; an information acquisition step for acquiring sensing information to which a paint color of the vehicle body corresponds, the sensing information at least including a position of a cross-section to be sensed on an edge of the opening part; a sensing step for sensing the cross-section to be sensed, which is set in advance, on the edge of the opening part; a calculation step for calculating an installation position of the vehicle windshield according to a sensing result acquired through sensing; and an installation step for installing the vehicle windshield to the opening part according to the installation position of the vehicle windshield that is calculated.

To make the above features and advantages of the present invention more comprehensible, several embodiments accompanied with drawings are described in detail as follows.

### BRIEF DESCRIPTION OF THE DRAWINGS

FIG. 1 is a schematic perspective view illustrating that a vehicle windshield installation device according to an embodiment of the disclosure at a time of installing a vehicle windshield.

FIG. 2 is a schematic diagram illustrating an electrical configuration of the vehicle windshield installation device shown in FIG. 1.

FIG. 3 is a schematic view illustrating an operation of a sensing member shown in FIGS. 1 and 2.

FIG. 4 is a schematic view illustrating an operation in which the sensing member shown in FIG. 3 senses cross-sections to be sensed that are set in advance.

FIG. 5 is a view illustrating an operation in which a calculation member shown in FIG. 2 calculates an installation position of the vehicle windshield according to a sensing result acquired through sensing.

FIG. 6 is a schematic flowchart illustrating a vehicle windshield installation method according to an embodiment of the disclosure.

FIG. 7 is a schematic flowchart illustrating a preliminary process required for sensing information used in an information acquisition step shown in FIG. 6.

FIG. 8 is a schematic view illustrating an operation of a setting step used in the preliminary process shown in FIG. 7.

FIG. 9 is a schematic flowchart of a preliminary process shown in FIG. 7 according to a modified example.

FIG. 10 is a schematic view illustrating an operation of a setting step used in the preliminary process shown in FIG. 9.

### DESCRIPTION OF THE EMBODIMENTS

An aspect of the disclosure provides a vehicle windshield installation device. The vehicle windshield installation device is adapted to install a vehicle windshield to an opening part of a vehicle body and includes: a holding member, holding the vehicle windshield; an information acquisition member, acquiring sensing information to which a paint color of the vehicle body corresponds, the sensing information at least including a position of a cross-section to be sensed on an edge of the opening part; a sensing member, sensing the cross-section to be sensed, which is set in advance, on the edge of the opening part; and a calculation member, calculating an installation position of the vehicle windshield according to a sensing result acquired through sensing. The holding member installs the vehicle windshield to the opening part according to the installation position of the vehicle windshield that is calculated.

According to an embodiment of the disclosure, the sensing member senses a cross-section waveform of the cross-section to be sensed on the edge of the opening part to acquire a feature point of the cross-section waveform, and the calculation member calculates the installation position of the vehicle windshield according to the feature point of the cross-section waveform that is sensed.

According to an embodiment of the disclosure, the vehicle windshield installation device further includes: a storage member, storing in advance the sensing information corresponding to multiple paint colors; and a driving member, driving the sensing member to sense, above a position of the cross-section to be sensed, the cross-section to be sensed based on the sensing information.

According to an embodiment of the disclosure, the storage member stores positions of multiple cross-sections to be sensed for at least one of the paint colors, the sensing member senses the cross-section waveform of each of the cross-sections to be sensed on the edge of the opening part to acquire the feature point of each of the cross-section waveforms, and the calculation member calculates the installation position of the vehicle windshield according to the feature points of the cross-section waveforms that are sensed.

According to an embodiment of the disclosure, the storage member stores a sensing condition to which the paint colors correspond.

An aspect of the disclosure provides a vehicle windshield installation method. The vehicle windshield installation method is adapted to install a vehicle windshield to an opening part of a vehicle body and includes: a holding step for holding the vehicle windshield; an information acquisition step for acquiring sensing information to which a paint color of the vehicle body corresponds, the sensing information at least including a position of a cross-section to be sensed on an edge of the opening part; a sensing step for sensing the cross-section to be sensed, which is set in advance, on the edge of the opening part; a calculation step for calculating an installation position of the vehicle windshield according to a sensing result acquired through sensing; and an installation step for installing the vehicle windshield to the opening part according to the installation position of the vehicle windshield that is calculated.

According to an embodiment of the disclosure, in the sensing step, sensing is performed on a cross-section waveform of the cross-section to be sensed on the edge of the opening part to acquire a feature point of the cross-section waveform, and in the calculation step, the installation position of the vehicle windshield is calculated according to the feature point of the cross-section waveform that is sensed.

According to an embodiment of the disclosure, the vehicle windshield installation method further includes: a three-dimensional model acquisition step for acquiring a three-dimensional model of the vehicle body; a cross-section acquisition step for acquiring all cross-sections on the edge of the opening part from the three-dimensional model that is acquired; an estimation step for estimating cross-section waveforms of all the cross-sections on the edge of the opening part that are acquired after the paint color, which is set in advance, is painted; and a setting step for setting at least one of all the cross-sections after the paint color is taken into consideration as the cross-section to be sensed.

According to an embodiment of the disclosure, in the setting step, multiple cross-sections of all the cross-sections after the paint color is taken into consideration are set as the cross-sections to be sensed, in the sensing step, sensing is performed on the cross-section waveform of each of the cross-sections to be sensed on the edge of the opening part to acquire a feature point of each of the cross-section waveforms, and in the calculation step, the installation position of the vehicle windshield is calculated according to the feature points of the cross-section waveforms that are sensed.

According to an embodiment of the disclosure, in response to the installation position of the vehicle windshield being unable to be calculated according to a feature point of the cross-section waveform that is sensed in the calculation step, sensing is performed on an alternative cross-section to be sensed, which is set in advance, on the edge of the opening part in the sensing step.

Based on the above, in the vehicle windshield installation device and the vehicle windshield installation method according to the embodiments of the disclosure, the sensing information (at least including the positions of the cross-sections to be sensed on the edge of the opening part) corresponding to the paint color of the vehicle body is acquired, sensing is performed on the cross-sections to be sensed that are set in advance on the edge of the opening part, and the installation position of the vehicle windshield is calculated according to the sensing result acquired sensing. In this way, the vehicle windshield can be installed to the opening part according to the installation position of the vehicle windshield that is calculated. In this way, the cross-sections to be sensed are properly set in advance for different paint colors, and, in the case where the vehicle body is painted a paint color, sensing is performed in accordance with the sensing information (i.e., the position of the cross-section to be sensed) corresponding to the paint color of the vehicle body, so as to sense the cross-section waveforms having the feature points at suitable positions, thereby more accurately calculating the installation position of the vehicle windshield. Thus, the vehicle windshield installation device and the vehicle windshield installation method according to the embodiments of the disclosure are capable of taking into consideration the paint color of the vehicle body and accurately installing the vehicle windshield.

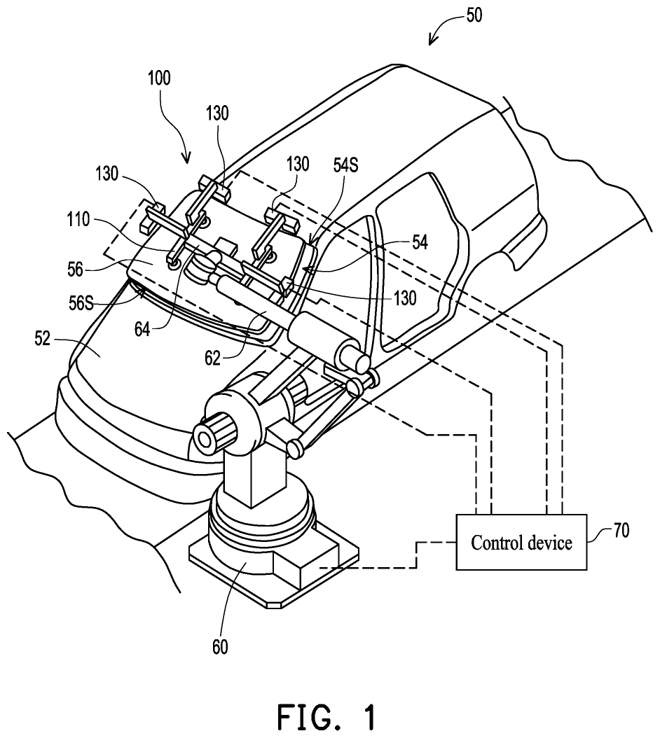

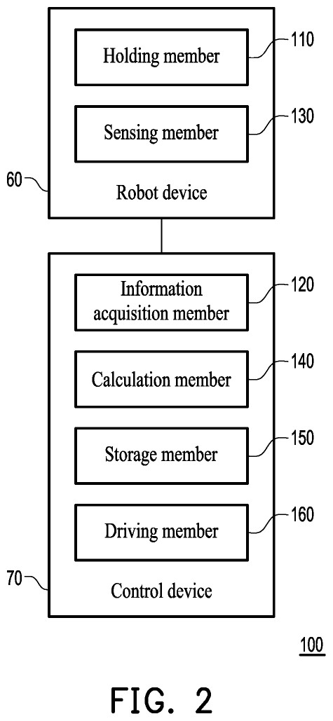

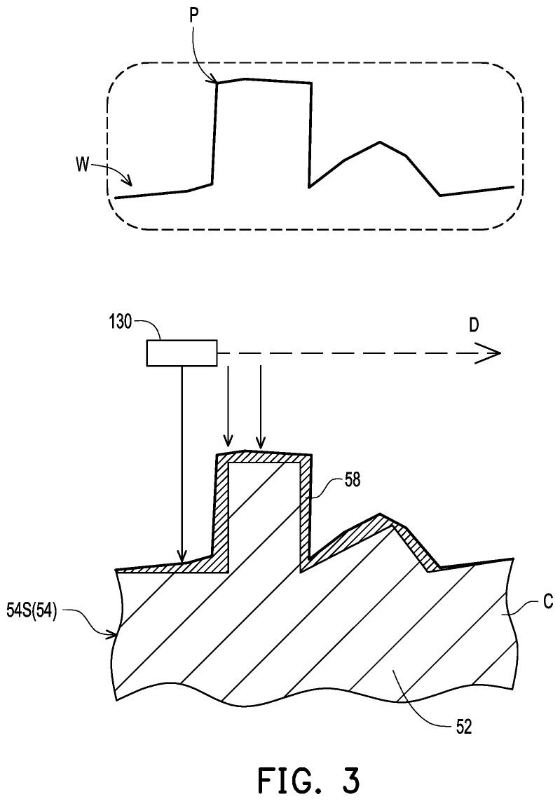

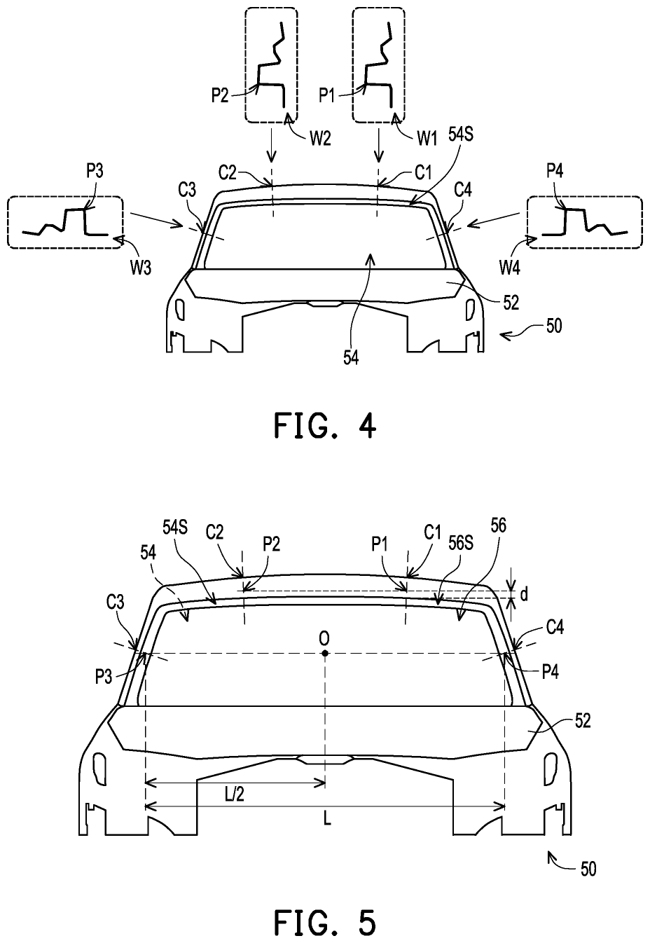

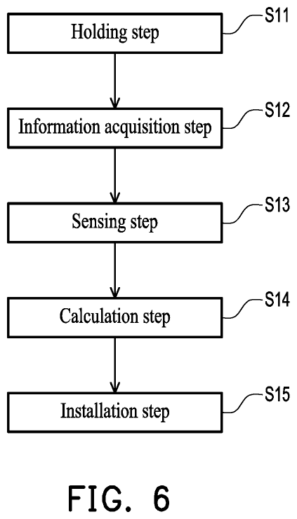

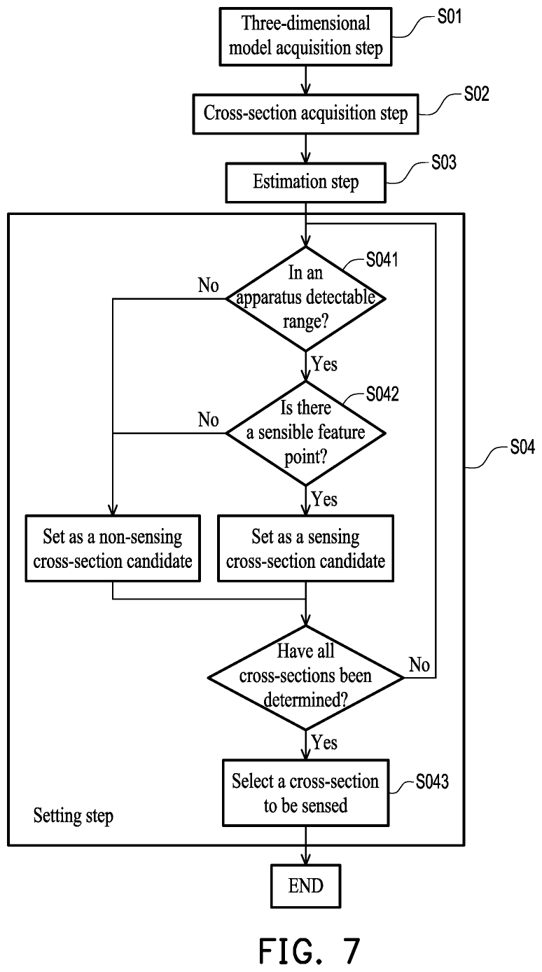

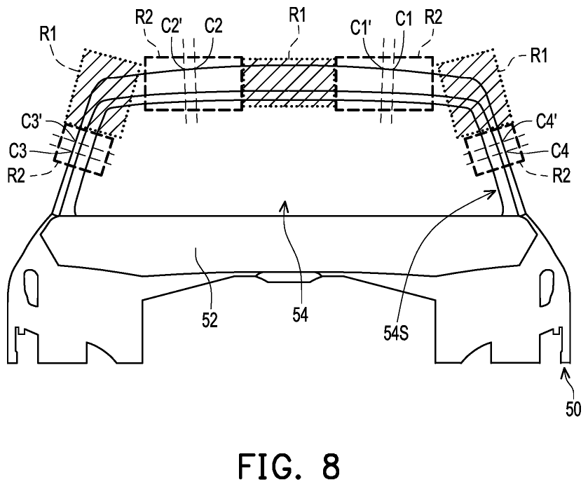

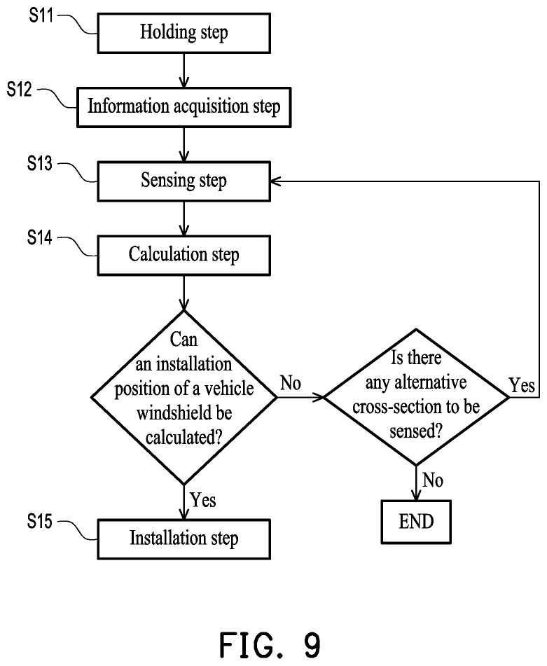

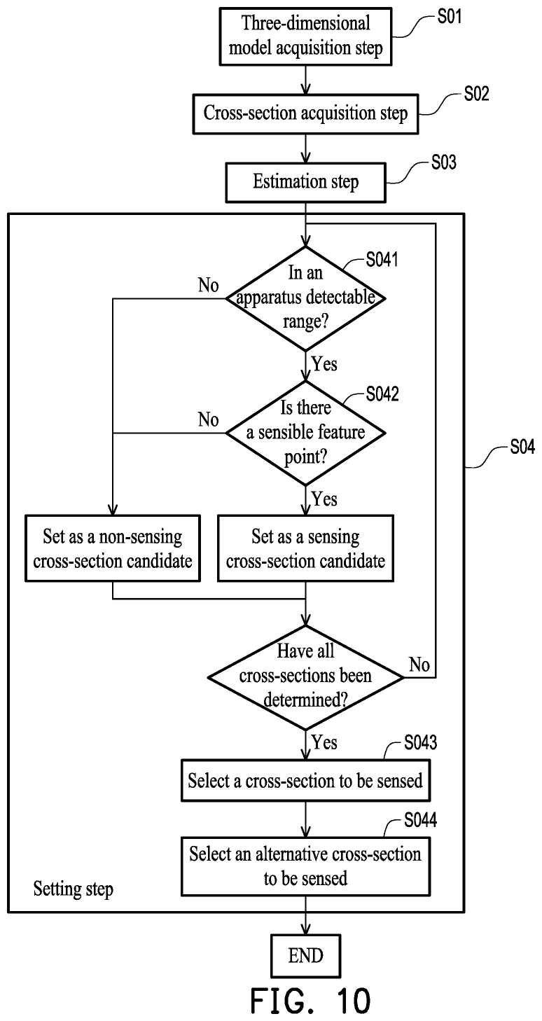

Reference will now be made in detail to the exemplary embodiments of the disclosure, examples of which are illustrated in the accompanying drawings. FIG. 1 is a schematic perspective view illustrating that a vehicle windshield installation device according to an embodiment of the disclosure at a time of installing a vehicle windshield. FIG. 2 is a schematic diagram illustrating an electrical configuration of the vehicle windshield installation device shown in FIG. 1. FIG. 3 is a schematic view illustrating an operation of a sensing member shown in FIGS. 1 and 2. FIG. 4 is a schematic view illustrating an operation in which the sensing member shown in FIG. 3 senses cross-sections to be sensed that are set in advance. FIG. 5 is a view illustrating an operation in which a calculation member shown in FIG. 2 calculates an installation position of the vehicle windshield according to a sensing result acquired through sensing. FIG. 6 is a schematic flowchart illustrating a vehicle windshield installation method according to an embodiment of the disclosure. FIG. 7 is a schematic flowchart illustrating a preliminary process required for sensing information used in an information acquisition step shown in FIG. 6. FIG. 8 is a schematic view illustrating an operation of a setting step used in the preliminary process shown in FIG. 7. FIG. 9 is a schematic flowchart of a preliminary process shown in FIG. 7 according to a modified example. FIG. 10 is a schematic view illustrating an operation of a setting step used in the preliminary process shown in FIG. 9. In the following, a detailed configuration of a vehicle windshield installation device 100 according to an embodiment of the disclosure and a detailed process of a vehicle windshield installation method according to an embodiment of the disclosure will be described with reference of FIGS. 1 to 10. However, the embodiments merely serve as examples, and the disclosure shall not be construed as being limited thereto.

Referring to FIGS. 1 and 2, in the embodiment, an opening 54 is provided in a vehicle body 52 of a vehicle 50. In addition, the opening 54 is adapted to install a vehicle windshield 56 to serve as a vehicle window. The vehicle window is, for example, a front window glass (also referred to as windshield) on the front side of the vehicle 50, and is fixed to the opening part 54 after being installed. However, the disclosure does not intend to limit how the vehicle windshield 56 is applied (i.e., the type of the vehicle window is not limited). In addition, the vehicle windshield installation device 100 is adapted to install the vehicle windshield 56 to the opening part 54 of the vehicle body 52. The vehicle windshield installation device 100 includes a holding member 110, an information acquisition member 120, a sensing member 130, and a calculation member 140. The holding member 110 holds the vehicle windshield 56. The information acquisition member 120 acquires sensing information corresponding to a paint color of the vehicle body 52. The sensing information at least includes a position of a cross-section to be sensed (e.g., four cross-sections C1 to C4 to be sensed as shown in FIG. 4 to be discussed afterwards) on an edge 54S of the opening part 54. The sensing member 130 senses the cross-section (e.g., the cross-sections C1 to C4) to be sensed that is set in advance on the edge 54S of the opening part 54. The calculation member 140 calculates the installation position of the vehicle windshield 56 according to a sensing result acquired through sensing. Accordingly, the holding member 110 installs the vehicle windshield 56 to the opening part 54 according to the installation position of the vehicle windshield 56 as calculated.

Specifically, in the embodiment, as shown in FIGS. 1 and 2, the holding member 110 is, for example, a fixture, such as a suction cup or a clamp, installed to the tip of a robot arm 62 provided in a robot device 60, and holds the vehicle windshield 56 through sucking or clamping. In this way, the holding member 110 is able to retrieve the vehicle windshield 56 from a vehicle windshield storage area (not shown) provided near the vehicle body 52, move to above the opening part 54 of the vehicle body 52 through the driving of the robot arm 62, etc., so as to standby above the opening part 54 in a manner substantially corresponding to the edge 54S of the opening part 54. The information acquisition member 120 is formed by a control device 70 different from the robot device 60, for example, and is configured to acquire the sensing information corresponding to the paint color of the vehicle body 52. The sensing information at least includes the position of the cross-section (e.g., the cross-sections C1 to C4) to be sensed on the edge 54S of the opening part 54, and is set in advance (as will be explicated in the following) in correspondence with the model and the paint color of the vehicle body 52 before the vehicle windshield 56 is installed to the vehicle body 52. Specifically, depending on different models and different paint colors with respect to the vehicle body 52, the exact position of the cross-section to be sensed that is set in advance differs. For example, through simulation or repetitive testing for different paint colors of the vehicle body 52 of a specific model, the positions of one or more cross-sections, among all the cross-sections on the edge 54S of the opening part 54, is acquired. Details in this regard will be explicated in the following. However, the disclosure does not intend to limit that the information acquisition member 120 is formed by the control device 70 different from the robot device 60. The information acquisition member 120 may also be formed by a control unit installed in the robot device 60.

Moreover, in the embodiment, as shown in FIGS. 1 and 2, the sensing member 130 is, for example, a sensor (e.g., a light sensor, an image sensor, etc.) installed to the tip of the robot arm 62 provided in the robot device 60, so as to sense the cross-section (e.g., the cross-sections C1 to C4) to be sensed that is set in advance on the edge 54S of the opening part 54. In addition, the sensing member 130 is disposed near the holding member 110. For example, a holder 64 is disposed at the tip of the robot arm 62, a middle part of the holder 64 is configured as a sucking fixture of the holding member 110, and an end of the holder 64 is configured as the sensor of the sensing member 130. In particular, the sensing member 130 is disposed at a position corresponding to an edge 56S of the vehicle windshield 56. In this way, as shown in FIG. 1, when the holding member 110 is moved to above the opening part 54 of the vehicle body 52 through driving of the robot arm 62, etc., the sensing member 130 is moved at the same time to above the opening part 54 of the vehicle body 52 through driving of the robot arm 62, etc. At this time, the sensing member 130 disposed at the position corresponding to the edge 56S of the vehicle windshield 56 also corresponds to the position of the edge 54S of the opening part 54. Therefore, the sensing member 130 is able to perform sensing above the opening part 54 to sense the cross-section (e.g., the cross-sections C1 to C4) to be sensed that is set in advance on the edge 54S of the opening part 54.

Accordingly, in the embodiment, as shown in FIG. 3, the sensing member 130 sensing a cross-section C to be sensed that is set in advance on the edge 54S of the opening part 54 means that, in a state in which the information acquisition member 120 has acquired the sensing information (at least including the position of the cross-section C to be sensed that is set in advance on the edge 54S of the opening part 54) corresponding to the paint color of the vehicle body 52, the sensing member 130 is moved to above the cross-section C to be sensed through driving of the robot arm 62, and is moved along a scan direction D from a side of the cross-section C to be sensed to the other side (such as being moved from the inner side to the outer side) to sense the cross-section C to be sensed that is set in advance on the edge 54S of the opening part 54. As an example, the sensing member 130 may sense a cross-section waveform W of the cross-section C to be sensed on the edge 54S of the opening part 54 to acquire a feature point P of the cross-section waveform W. For example, the displacement variation amounts at respective positions along a path on which the sensing light of the sensing member 130 moves along the scan direction D are connected to form the cross-section waveform W. In addition, the position with the greatest displacement variation amount in the cross-section waveform W is set as the feature point P of the current cross-section waveform W. At this time, although the vehicle body 52 has been painted and therefore has a paint layer 58 on the outer side of the cross-section C to be sensed on the edge 54S of the opening part 54, the exact position of the cross-section C to be sensed is set in advance by taking into consideration the paint color. Therefore, the feature point P that is sensed is able to reflect the feature point P of the cross-section C in a state where the vehicle body 52 is not painted. Therefore, the influence due to paint color can be alleviated.

In addition, in the embodiment, as shown in FIGS. 1 and 4, the sensing member 130 may perform sensing on multiple cross-sections to be sensed that are set in advance on the edge 54S of the opening part 54. For example, the sensing member 130 may perform sensing on four cross-sections C1 to C4 to be sensed, as shown in FIG. 4, that are set in advance on the edge 54S of the opening part 54. The exact positions of the four cross-sections C1 to C4 to be sensed may differ, depending on different models and/or paint colors, and are acquired in advance through the information acquisition member 120. It may also be that multiple sensing members 130 (e.g., four sensing members as shown in FIG. 1) are disposed to correspondingly sense cross-section waveforms W1 to W4 of the cross-sections C1 to C4 to be sensed as shown in FIG. 4, without having to move a single sensing member 130 to above the four cross-sections C1 to C4 to be sensed successively through driving of the robot arm 62. However, the disclosure is not limited thereto. The cross-section waveforms W1 to W4 of the four cross-sections C1 to C4 to be sensed may be sensed successively under the control of the robot arm 62. Alternatively, one or more of the cross-section waveforms W1 to W4 of the cross-sections C1 to C4 to be sensed may also be sensed at the same time (e.g., the cross-sections C1 and C2 having the same scan direction may be sensed at the same time). However, the disclosure does not intend to impose a limitation on this regard. In this way, after sensing the respective cross-section waveforms W1 to W4 of the cross-sections C1 to C4 to be sensed, the sensing member 130 is able to acquire respective feature points P1 to P4 of the cross-section waveforms W1 to W4. For example, the positions with the greatest displacement variation amounts in the cross-section waveforms W1 to W4 are set as feature points P1 to P4 of the current cross-section waveforms W1 to W4.

Also, in the embodiment, as shown in FIGS. 2 and 5, the calculation member 140 is, for example, formed to be different from the control device 70 of the robot device 60, and is configured to calculate the installation position of the vehicle windshield 56 according to the sensing result acquired through sensing. For example, after the sensing member 130 senses the respective cross-section waveforms W1 to W4 of the four cross-sections C1 to C4 to be sensed that are set in advance and acquires the respective feature points P1 to P4 of the cross-section waveforms W1 to W4 as shown in FIG. 4, the calculation member 140 calculates the installation position of the vehicle windshield 56 according to the feature points P1 to P4 of the cross-section waveforms W1 to W4 that are sensed. For example, with a central point O of the opening part 54 as reference, the cross-sections C1 and C2 to be sensed are set at positions at the same horizontal height on the upper side of the edge 54S of the opening part 54, and the cross-sections C3 and C4 to be sensed are set at positions at the same horizontal height on the left side and the right side of the edge 54 of the opening part 54. As described above, the exact positions of the four cross-sections C1 to C4 to be sensed are set in advance according to the paint color of the vehicle body 52 and may differ as the model of the vehicle body 52 differs. In this way, the calculation member 140 sets the height of the vehicle windshield 56 on the upper side by using the feature points P1 and P2 of the two cross-sections C1 and C2 to be sensed corresponding to the upper side of the edge 54S of the opening part 54, and sets the central position of the vehicle windshield 56 by using the feature points P3 and P4 of the two cross-sections C3 and C4 to be sensed corresponding to the left and right sides of the edge 54S of the opening part 54.

More specifically, as an example, the position of the vehicle body 52 is set so that the difference between the feature points P1 and P2 becomes zero (i.e., being level). In other words, the edge 54S on the upper side of the opening part 54 is configured to be level. In addition, a position lower than the feature points P1 and P2 by a predetermined distance d (e.g., 10 mm) on the edge 54S of the opening part 54 is set as the upper end height position of the edge 56S on the upper side of the vehicle windshield 56. In addition, the robot arm 62 rotates the vehicle windshield 56 held by the holding member 110, so that the edge 56S on the upper side of the vehicle windshield 56 becomes level. In addition, the robot arm 62 moves the vehicle windshield 56 held by the holding member 110, so that the edge 56S on the upper side of the vehicle windshield 56 is aligned to the upper end height position as calculated. Moreover, a middle position (e.g., the position corresponding to the central point O of the opening part 54) between the feature points P3 and P4 is set as the central position of the vehicle windshield 56 in the width direction. In other words, the central position is a position at a half (L/2) of a length L of the vehicle windshield 56 in the left-right direction. In addition, the robot arm 62 moves the vehicle windshield 56 held by the holding member 110, so that the center of the vehicle windshield 56 in the width direction is aligned to the central position as calculated. Accordingly, the holding member 110 installs the vehicle windshield 56 to the opening part 54 according to the installation position of the vehicle windshield 56 as calculated. However, the disclosure does not intend to limit that the calculation member 140 is formed to be different from the control device 70 of the robot device 60, and may also be formed by the control unit installed to the robot device 60. In addition, the disclosure does not intend to limit how the calculation member 140 performs calculation, and such calculation may be modified in accordance with the position of the cross-section that is set in advance.

Moreover, in the embodiment, as shown in FIG. 2, the vehicle windshield installation device 100 further includes a storage member 150. The storage member 150 stores in advance sensing information corresponding to multiple paint colors. For example, the storage member 150 stores the positions of the cross-sections C1 to C4 to be sensed for at least one of multiple paint colors. As an example, the storage member 150 may store in advance the positions of the one or more cross-sections C1 to C4 to be sensed corresponding to the case where the paint color of a first model is white, the positions of the one or more cross-sections C1 to C4 to be sensed corresponding to the case where the paint color of a second model is white, the positions of the one or more cross-sections C1 to C4 to be sensed corresponding to the case where the paint color of the first model is black, and the positions of the one or more cross-sections C1 to C4 to be sensed corresponding to the case where the paint color of the second model is black. As an example, the storage member 150 may store sampling time, as a sensing condition, corresponding to the paint colors. For example, the storage member 150 stores in advance the sensing information, such as a sampling time corresponding to the case where the paint color is white and a sampling time corresponding to the case where the paint color is black, etc. The sampling time refers to the movement time (movement speed) when the sensing member 130 senses the cross-sections C1 to C4 to be sensed, for example. Depending on different paint colors, the sampling time of the sensing member 130 may be set different. For example, in the case where the paint color is black, the sampling time is set to be longer than that of the case when the paint color is white, as black color hardly reflects light. However, it may also be that the same sampling time is set for different paint colors. The paint color is not limited to being white or black and may include a greater variety of colors. Moreover, in addition to the sampling time, as the sensing condition, an optimal sensing condition, such as a sensing light irradiation environment or a processing condition, for each paint color may also be stored in advance. The storage member 150 may be formed to be different from the control device 70 of the robot device 60, and may also be formed by the control unit installed to the robot device 60, for example. The disclosure does not intend to impose a limitation on this regard.

In addition, in the embodiment, as shown in FIG. 2, the vehicle windshield installation device 100 further includes a driving member 160. The driving member 160 drives the sensing member 130 to sense, above the positions of the cross-sections C1 to C4 to be sensed, the cross-sections C1 to C4 to be sensed based on the sensing information. In other words, the information acquisition member 120, for example, acquires the sensing information corresponding to the paint color of the vehicle body 52 (e.g., the positions of the four cross-sections C1 to C4 to be sensed as shown in FIG. 4) from the storage member 150, and the driving member 160 drives the sensing member 130 to above the positions of the cross-sections C1 to C4 to be sensed in accordance with the acquired sensing information (i.e., the positions of the cross-sections C1 to C4), so as to sense the cross-sections C1 to C4 to be sensed. In this way, the sensing member 130 senses the respective cross-section waveforms W1 to W4 of the cross-sections C1 to C4 to be sensed on the edge 54S of the opening part 54 to acquire the respective feature points P1 to P4 of the cross-section waveforms W1 to W4. In addition, the calculation member 140 calculates the installation position of the vehicle windshield 56 according to the feature points P1 to P4 of the cross-section waveforms W1 to W4 that are sensed. The driving member 160 may be formed to be different from the control device 70 of the robot device 60, and may also be formed by the control unit installed to the robot device 60, for example. The disclosure does not intend to impose a limitation on this regard.

Thus, in the vehicle windshield installation device 100 according to the embodiment, the information acquisition member 120 acquires the sensing information (at least including the positions of the cross-sections C1 to C4 to be sensed on the edge 54S of the opening part 54) corresponding to the paint color of the vehicle body 52, the sensing member 130 senses the cross-sections C1 to C4 to be sensed that are set in advance on the edge 54S of the opening part 54, and the calculation member 140 calculates the installation position of the vehicle windshield 56 according to the sensing result acquired through sensing. In this way, the vehicle windshield installation device 100 is able to install the vehicle windshield 56 to the opening part 54 according to the installation position of the vehicle windshield 56 that is calculated. In this way, the cross-sections C1 to C4 to be sensed are properly set in advance for different paint colors. In the case where the vehicle body 52 is painted a paint color, the vehicle windshield installation device 100 performs sensing in accordance with the sensing information (i.e., the positions of the cross-sections C1 to C4 to be sensed) corresponding to the paint color of the vehicle body 52, so as to sense the cross-section waveforms W1 to W4 having the feature points P1 to P4 at suitable positions, thereby more accurately calculating the installation position of the vehicle windshield 56. Accordingly, the vehicle windshield installation device 100 can take into consideration the paint color of the vehicle body 52 and accurately install the vehicle windshield 56.

Referring to FIGS. 1 and 6, in the embodiment, the vehicle windshield installation method is suitable for installing the vehicle windshield 56 to the opening part 54 of the vehicle body 52. The vehicle windshield installation method may be executed by the vehicle windshield installation device 100 as shown in FIGS. 1 and 2, for example. However, the disclosure is not limited thereto. The vehicle windshield installation method includes steps as follows: a holding step S11 for holding the vehicle windshield 56; an information acquisition Step S12 for acquiring the sensing information corresponding to the paint color of the vehicle body 52, the sensing information at least including the position of the cross-section to be sensed (e.g., the four cross-sections C1 to C4 as shown in FIG. 4) on the edge 54S of the opening part 54; a sensing step S13 for sensing the cross-section (e.g., the cross-sections C1 to C4) to be sensed that is set in advance on the edge 54S of the opening part 54; a calculation step S14 for calculating the installation position of the vehicle windshield 56 according to the sensing result acquired through sensing; and an installation step S15 for installing the vehicle windshield 56 to the opening part 54 in accordance with the installation position of the vehicle windshield 56 that is calculated.

Specifically, in the embodiment, the holding step S11 is executed by the holding member 110 shown in FIG. 1, for example. In other words, the vehicle windshield 56 is held by the holding member 110. The information acquisition step S12 is executed by the information acquisition member 120 shown in FIG. 2, for example. That is, the sensing information, such as the positions of the four cross-sections C1 to C4 to be sensed as shown in FIG. 4, corresponding to the paint color of the vehicle body 52 is acquired by the information acquisition member 120. The sensing step S13 is executed by the sensing member 130 as shown in FIG. 1, for example. That is, sensing is performed on the cross-sections C1 to C4 to be sensed that are set in advance on the edge 54S of the opening part 54 by the sensing member 130. The calculation step S14 is executed by the calculation member 140 as shown in FIG. 2, for example. That is, the installation position of the vehicle windshield 56 is calculated by the calculation member 140 according to the sensing result acquired through sensing. The installation step S15 is executed by the holding member 110 shown in FIG. 1, for example. That is, the holding member 110 installs the vehicle windshield 56 to the opening part 54 according to the installation position of the vehicle windshield 56 as calculated. However, the disclosure does not intend to limit the means for executing the respective steps of the vehicle windshield installation method. Such means of execution may be modified as needed.

Moreover, in the embodiment, sensing the cross-section C to be sensed that is set in advance on the edge 54S of the opening part 54 in the sensing step S13 means that, as shown in FIG. 3, in the state in which the information acquisition member 120 has acquired the sensing information (at least including the position of the cross-section C to be sensed that is set in advance on the edge 54S of the opening part 54) corresponding to the paint color of the vehicle body 52, sensing is performed on the cross-section waveform W of the cross-section C to be sensed on the edge 54S of the opening part 54 in the sensing step S13 to acquire the feature point P of the cross-section waveform W, as described above. As an example, as shown in FIG. 4, in the sensing step S13, the respective cross-section waveforms W1 to W4 of the cross-sections C1 to C4 to be sensed on the edge 54S of the opening part 54 may be sensed to acquire the respective feature points P1 to P4 of the cross-section waveforms W1 to W4, as described above. In addition, calculating the installation position of the vehicle windshield 56 according to the sensing result acquired through sensing in the calculation step S14 means that, as shown in FIG. 5, the installation position of the vehicle windshield 56 is calculated according to the feature point (e.g., the feature points P1 to P4) of the cross-section waveform (e.g., the cross-section waveforms W1 to W4) that is sensed, as described above. The steps may be executed in accordance with the order shown in FIG. 6. However, the order of one or more steps may also be adjusted as needed. For example, the order between the holding step S11 and the information acquisition step S12 may be switched. The disclosure does not intend to impose a limitation on this regard.

Moreover, in the embodiment, the exact positions of the cross-sections C1 to C4 to be sensed (i.e., the sensing information used in the information acquisition step S12) set in advance for different paint colors may be acquired through a preliminary process and stored in the storage member 150 shown in FIG. 2. However, the disclosure does not intend to impose a limitation on this regard. As shown in FIG. 7, the vehicle windshield installation method further includes: a three-dimensional model acquisition step S01 for acquiring a three-dimensional model of the vehicle body 52; a cross-section acquisition step S02 for acquiring the cross-sections on the edge 54S of the opening part 54 from the acquired three-dimensional model; an estimation step S03 for estimating the cross-section waveforms of all the cross-sections on the edge 54S of the opening part 54 that are acquired after the paint color set in advance is painted; and a setting step S04 for setting at least one of all the cross-sections after the paint color is taken into consideration as the cross-section to be sensed. The steps (i.e., the three-dimensional model acquisition step S01 to the setting step S04) in the preliminary process are executed before the steps (e.g., the holding step S11 to the installation step S15) in the main process, for example, and are particularly executed before the information acquisition step S12. Accordingly, the sensing information (i.e., the positions of the cross-sections to be sensed) set in advance has been acquired in the information acquisition step S12. However, the disclosure is not limited thereto and may be adjusted as needed.

Specifically, in the embodiment, firstly, the three-dimensional model of the vehicle body 52 is acquired from a database at the manufacturing end, for example, in the three-dimensional model acquisition step S01, as shown in FIGS. 7 and 8. The three-dimensional model may differ as the model to which the vehicle body 52 corresponds differs. Specifically, the three-dimensional model at least shows the three-dimensional structure around the opening part 54 of the vehicle body 52. Then, in the cross-section acquisition step S02, the edge 54S of the opening part 54 in the three-dimensional model of the vehicle body 52 is cut successively by using simulation software, for example, to acquire all the cross-sections on the edge 54S of the opening part 54. Then, in the estimation step S03, the cross-section waveforms after the paint color set in advance is painted in all the cross-sections on the edge 54S of the opening part 54 that are acquired are estimated through simulation or repetitive testing according to different paint colors. For example, when the vehicle body 52 is painted black, as black color hardly reflects light, the outline of the cross-section of the edge 54S of the opening 54 in the vehicle body 52 becomes unclear. Correspondingly, when the vehicle body 52 is painted white, as white color reflects light easily, the outline of the cross-section of the edge 54S of the opening part 54 in the vehicle body 52 is rough. Machine learning is carried out repetitively in the simulation software according to the properties of the paint colors, such as the reflection of the sensing light for the paint colors, etc., or actual tests are carried out in a test stage of the vehicle body 52 to repetitively update the database for the simulation software. In this way, the cross-section waveforms after the paint color set in advance is painted in all the cross-sections on the edge 54S of the opening part 54 that are acquired can be more accurately estimated.

Then, as shown in FIG. 7, the setting step S04 further includes additional steps as follows. After the cross-section waveforms after the paint color set in advance is painted in all the cross-sections on the edge 54S of the opening part 54 that are acquired are estimated in the estimation step S03, firstly, at an additional step S041, whether the cross-sections are in an apparatus detectable range is determined. That is, whether the sensing member 130 and/or the robot arm 62, etc., that are/is applied are/is able to correspondingly move to above the cross-sections at the time of installing the vehicle windshield 56 to the vehicle body 52. If it is determined that the sensing member 130/the robot arm 62, etc., that are/is used are/is not able to correspondingly move to above a cross-section, the cross-section is set as a non-sensing cross-section candidate and not considered. If it is determined that the sensing member 130/the robot arm 62, etc., that are/is used are/is able to correspondingly move to above a cross-section, the cross-section is further determined. That is, in an additional step S042, whether the cross-section waveform of the cross-section has a sensible feature point is determined (e.g., whether the cross-section waveform has at least one point with a displacement variation amount of 5 mm or more is determined, but the disclosure is not limited thereto). If it is determined that the cross-section waveform of the cross-section does not have a sensible feature point, the cross-section is set as a non-sensing cross-section candidate and not considered. If it is determined that the cross-section waveform of the cross-section has a detectable feature point, the cross-section is set as a sensing cross-section candidate and taken into consideration. After all the cross-sections are determined, as shown in FIG. 8, three non-sensing candidate ranges R1 formed by the non-sensing cross-section candidates and four sensing candidate ranges R2 formed by the sensing cross-section candidates are acquired. Lastly, in an additional step S043, the cross-sections having the feature point with the greatest displacement variation amount are chosen from the sensing candidate ranges R2 to serve as the cross-sections to be sensed of the model corresponding to a specific paint color. For example, as shown in FIG. 8, the cross-sections C1 to C4 having the feature points P1 to P4 with the greatest displacement variation amounts are respectively chosen from the four sensing candidate ranges R2.

In this way, setting is performed for different paint colors of the same model. In addition, such setting may also be performed for various paint colors of different models. It is not required that the preliminary process be executed at the site of installation. For example, the preliminary process may be performed through simulation by using simulation software during the model design stage of the vehicle body 52, and may also be performed by actually installing the vehicle windshield 56 and feeding error values present at the current stage to simulation software for the simulation software to perform machine learning. In this way, the exact positions of the cross-sections C1 to C4 to be sensed are set properly, with the paint color being accurately taken into consideration. After the sensing information corresponding to the various paint colors of each model is acquired through the preliminary process, the sensing information may be stored in advance in the storage member 150. However, the disclosure is not limited thereto. As an example, in the setting step S04, the cross-sections of all the cross-sections after the paint color is taken into consideration may be set as the cross-sections to be sensed (e.g., the cross-sections C1 to C4 to be sensed as shown in FIG. 8). Consequently, in the sensing step S13 shown in FIG. 7, sensing is performed on the respective cross-section waveforms W1 to W4 of the four cross-sections C1 to C4 to be sensed on the edge 54S of the opening part 54 to acquire the respective feature points P1 to P4 (as shown in FIG. 4) of the cross-section waveforms W1 to W4. In addition, in the calculation step S14 shown in FIG. 7, the installation position of the vehicle windshield 56 is calculated according to the feature points P1 to P4 of the cross-section waveforms W1 to W4 that are sensed (as shown in FIG. 5). In this way, when the vehicle windshield 56 is installed to the opening part 54 of the vehicle body 52 (i.e., at the site of installation) by using the vehicle windshield installation method, the cross-sections C1 to C4 to be sensed that are set in advance may be acquired according to the sensing information, such as the current model and paint color of the vehicle body 52, and sensing is performed only on the cross-sections C1 to C4 to be sensed in the state in which the holding member 110 holds the vehicle windshield 56 above the opening part 54, and it is not required to perform sensing on all the cross-sections of the edge 54S of the opening part 54. However, the disclosure does not intend to impose a limitation on the quantity (which may be one or more) of the cross-sections to be sensed that are set in advance. The quantity may be modified as needed.

In addition, in the embodiment, as shown in FIG. 9, after sensing is performed on the cross-sections C1 to C4 to be sensed in the sensing step S13 and the corresponding cross-section waveforms W1 to W4 and feature points P1 to P4 are acquired, if the installation position of the vehicle windshield 56 cannot be calculated according to the feature points P1 to P4 of the cross-section waveforms W1 to W4 that are sensed, whether there are still alternative cross-sections to be sensed is determined. If there are still alternative cross-sections to be sensed, sensing is performed on alternative cross-sections C1′ to C4′ to be sensed that are set in advance on the edge 54S of the opening part 54 in the sensing step S13 (as shown in FIG. 8). Specifically, as shown in FIG. 10, in the setting step S04 of the preliminary process, not only the four cross-sections C1 to C4 having the feature points P1 to P4 with the greatest displacement variation amounts are respectively chosen from the four sensing candidate ranges R2 in the additional step S043, but the four alternative cross-sections C1′ to C4′ to be sensed are also chosen respectively from the four sensing candidate ranges R2 in the additional step S044. As shown in FIG. 8, the alternative cross-sections C1′ to C4′ to be sensed may be, for example, cross-sections having the feature points with the second greatest displacement variation amounts and, for example, being located near the cross-sections C1 to C4 having the greatest displacement variation amounts in the sensing candidate ranges R2. However, the disclosure is not limited thereto. The alternative cross-sections C1′ to C4′ to be sensed may also be set in advance in the preliminary process and stored in the storage member 150 shown in FIG. 2. The alternative cross-sections to be sensed are not limited to only one set, and may also be multiple sets. However, the disclosure is not limited thereto.

In this way, as shown in FIG. 9, the installation position of the vehicle windshield 56 being unable to be calculated according to the feature points P1 to P4 of the cross-section waveforms W1 to W4 that are sensed in the calculation step S14 suggests that errors may be present in the cross-sections C1 to C4 to be sensed that are set in advance. Thus, whether there are still alternative cross-sections to be sensed is determined. If there are still alternative cross-sections to be sensed, sensing is performed on the alternative cross-sections C1′ to C4′ to be sensed that are set in advance on the edge 54S of the opening part 54 in the sensing step S13. When the installation position of the vehicle windshield 56 is still unable to be calculated according to the feature points of the cross-section waveforms sensed in the alternative cross-sections C1′ to C4′ to be sensed, if there are still a second set (or more sets) of alternative cross-sections to be sensed, sensing is performed on the alternative cross-sections to be sensed of the second set (or more sets) on the edge of the opening part 54 in the sensing step S13. If sensing is performed on all the alternative cross-sections to be sensed but the installation position of the vehicle windshield 56 cannot be calculated (i.e., there is no alternative cross-section to be sensed available), the process of installing the vehicle windshield 56 is stopped, and the sensing information set through simulation in the preliminary process is updated again. However, the disclosure does not intend to limit the quantity of the alternative cross-sections to be sensed that are set in advance and whether such alternative cross-sections are set. In the setting step of the vehicle windshield installation method, it may also be that alternative cross-sections to be sensed are not set in advance, and the process of installing the vehicle windshield 56 may be stopped when the installation position of the vehicle windshield 56 cannot be calculated in the calculation step S14. The specific means of the above process may be adjusted as needed.

Thus, in the vehicle windshield installation method according to the embodiment, the sensing information (at least including the positions of the cross-sections C1 to C4 to be sensed on the edge 54S of the opening part 54) corresponding to the paint color of the vehicle body 52 is acquired in the information acquisition step, sensing is performed on the cross-sections C1 to C4 to be sensed that are set in advance on the edge 54S of the opening part 54 in the sensing step S13, and the installation position of the vehicle windshield 56 is calculated in the calculation step S14 according to the sensing result acquired through sensing. In this way, the vehicle windshield 56 can be installed to the opening part 54 according to the installation position of the vehicle windshield 56 that is calculated. In this way, the cross-sections C1 to C4 to be sensed are properly set in advance for different paint colors. In the case where the vehicle body 52 is painted a paint color, the vehicle windshield installation device 100 performs sensing in accordance with the sensing information (i.e., the positions of the cross-sections C1 to C4 to be sensed) corresponding to the paint color of the vehicle body 52, so as to sense the cross-section waveforms W1 to W4 having the feature points P1 to P4 at suitable positions, thereby more accurately calculating the installation position of the vehicle windshield 56. Accordingly, the vehicle windshield installation method can take into consideration the paint color of the vehicle body 52 and accurately install the vehicle windshield 56.

In view of the foregoing, in the vehicle windshield installation device and the vehicle windshield installation method according to the embodiments of the disclosure, the sensing information (at least including the positions of the cross-sections to be sensed on the edge of the opening part) corresponding to the paint color of the vehicle body is acquired, sensing is performed on the cross-sections to be sensed that are set in advance on the edge of the opening part, and the installation position of the vehicle windshield is calculated according to the sensing result acquired through sensing. In this way, the vehicle windshield can be installed to the opening part according to the installation position of the vehicle windshield that is calculated. As an example, in the vehicle windshield installation device and the vehicle windshield installation method according to the embodiments of the disclosure, sensing may be performed on the cross-section waveform of the cross-section (or multiple cross-sections) to be sensed on the edge of the opening part to acquire the feature point (or multiple feature points) of the cross-section waveform, and the installation position of the vehicle windshield may be calculated according to the feature point of the cross-section waveform that is sensed. In this way, the cross-sections to be sensed are properly set in advance for different paint colors, and, in the case where the vehicle body is painted a paint color, sensing is performed in accordance with the sensing information (i.e., the position of the cross-section to be sensed) corresponding to the paint color of the vehicle body, so as to sense the cross-section waveforms having the feature points at suitable positions, thereby more accurately calculating the installation position of the vehicle windshield. Thus, the vehicle windshield installation device and the vehicle windshield installation method according to the embodiments of the disclosure are capable of taking into consideration the paint color of the vehicle body and accurately installing the vehicle windshield.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A vehicle windshield installation device, adapted to install a vehicle windshield to an opening part of a vehicle body, the vehicle windshield installation device comprising:
a holding member, holding the vehicle windshield;
an information acquisition member, acquiring sensing information to which a paint color of the vehicle body corresponds, wherein the sensing information at least comprises a position of a cross-section to be sensed on an edge of the opening part;
a sensing member, sensing the cross-section to be sensed, which is set in advance, on the edge of the opening part; and
a calculation member, calculating an installation position of the vehicle windshield according to a sensing result acquired through sensing,
wherein the holding member installs the vehicle windshield to the opening part according to the installation position of the vehicle windshield that is calculated.

2. The vehicle windshield installation device as claimed in claim 1, wherein the sensing member senses a cross-section waveform of the cross-section to be sensed on the edge of the opening part to acquire a feature point of the cross-section waveform, and
the calculation member calculates the installation position of the vehicle windshield according to the feature point of the cross-section waveform that is sensed.

3. The vehicle windshield installation device as claimed in claim 2, further comprising:
a storage member, storing in advance the sensing information corresponding to a plurality of paint colors; and
a driving member, driving the sensing member to sense, above a position of the cross-section to be sensed, the cross-section to be sensed based on the sensing information.

4. The vehicle windshield installation device as claimed in claim 3, wherein the storage member stores positions of a plurality of cross-sections to be sensed for at least one of the paint colors,
the sensing member senses the cross-section waveform of each of the cross-sections to be sensed on the edge of the opening part to acquire the feature point of each of the cross-section waveforms, and
the calculation member calculates the installation position of the vehicle windshield according to the feature points of the cross-section waveforms that are sensed.

5. The vehicle windshield installation device as claimed in claim 3, wherein the storage member stores a sensing condition to which the paint colors correspond.

6. A vehicle windshield installation method, adapted for installing a vehicle windshield to an opening part of a vehicle body, the vehicle windshield installation method comprising:
a holding step for holding the vehicle windshield;
an information acquisition step for acquiring sensing information to which a paint color of the vehicle body corresponds, wherein the sensing information at least comprises a position of a cross-section to be sensed on an edge of the opening part;
a sensing step for sensing the cross-section to be sensed, which is set in advance, on the edge of the opening part;
a calculation step for calculating an installation position of the vehicle windshield according to a sensing result acquired through sensing; and
an installation step for installing the vehicle windshield to the opening part according to the installation position of the vehicle windshield that is calculated.

7. The vehicle windshield installation method as claimed in claim 6, wherein in the sensing step, sensing is performed on a cross-section waveform of the cross-section to be sensed on the edge of the opening part to acquire a feature point of the cross-section waveform, and
in the calculation step, the installation position of the vehicle windshield is calculated according to the feature point of the cross-section waveform that is sensed.

8. The vehicle windshield installation method as claimed in claim 6, further comprising:
a three-dimensional model acquisition step for acquiring a three-dimensional model of the vehicle body;
a cross-section acquisition step for acquiring all cross-sections on the edge of the opening part from the three-dimensional model that is acquired;
an estimation step for estimating cross-section waveforms of all the cross-sections on the edge of the opening part that are acquired after the paint color, which is set in advance, is painted; and
a setting step for setting at least one of all the cross-sections after the paint color is taken into consideration as the cross-section to be sensed.

9. The vehicle windshield installation method as claimed in claim 8, wherein in the setting step, a plurality of cross-sections of all the cross-sections after the paint color is taken into consideration are set as the cross-sections to be sensed, in the sensing step, sensing is performed on the cross-section waveform of each of the cross-sections to be sensed on the edge of the opening part to acquire a feature point of each of the cross-section waveforms, and
in the calculation step, the installation position of the vehicle windshield is calculated according to the feature points of the cross-section waveforms that are sensed.

10. The vehicle windshield installation method as claimed in claim 6, wherein in response to the installation position of the vehicle windshield being unable to be calculated according to a feature point of the cross-section waveform that is sensed in the calculation step, sensing is performed on an alternative cross-section to be sensed, which is set in advance, on the edge of the opening part in the sensing step.

11. The vehicle windshield installation method as claimed in claim 7, further comprising:
a three-dimensional model acquisition step for acquiring a three-dimensional model of the vehicle body;
a cross-section acquisition step for acquiring all cross-sections on the edge of the opening part from the three-dimensional model that is acquired;
an estimation step for estimating cross-section waveforms of all the cross-sections on the edge of the opening part that are acquired after the paint color, which is set in advance, is painted; and
a setting step for setting at least one of all the cross-sections after the paint color is taken into consideration as the cross-section to be sensed.

12. The vehicle windshield installation method as claimed in claim 11, wherein in the setting step, a plurality of cross-sections of all the cross-sections after the paint color is taken into consideration are set as the cross-sections to be sensed,
in the sensing step, sensing is performed on the cross-section waveform of each of the cross-sections to be sensed on the edge of the opening part to acquire the feature point of each of the cross-section waveforms, and
in the calculation step, the installation position of the vehicle windshield is calculated according to the feature points of the cross-section waveforms that are sensed.

13. The vehicle windshield installation method as claimed in claim 7, wherein in response to the installation position of the vehicle windshield being unable to be calculated according to the feature point of the cross-section waveform that is sensed in the calculation step, sensing is performed on an alternative cross-section to be sensed, which is set in advance, on the edge of the opening part in the sensing step.
